(19) United States
(12) Patent Application Publication
(10) Pub. No.: US 2026/0095046 A1
(43) Pub. Date: Apr. 2, 2026

(54) POWER SUPPLY APPARATUS INCLUDING INTERLOCK FUNCTION AND IMAGE FORMING APPARATUS

(71) Applicant: CANON KABUSHIKI KAISHA, Tokyo (JP)

(72) Inventor: YOSUKE OBAYASHI, Chiba (JP)

(21) Appl. No.: 19/331,550

(22) Filed: Sep. 17, 2025

(30) Foreign Application Priority Data
Sep. 30, 2024 (JP) 2024-171513

(51) Int. Cl. H02J 3/00; B41J 3/44; B41J 29/393

(52) U.S. Cl. CPC H02J 3/001; B41J 3/44; B41J 29/393

(57) ABSTRACT

When a first interlock switch transitions from a second state to a first state, a controller switches a first relay from an on state to an off state and a second relay from the on state to the off state. When the first interlock switch transitions from the first state to the second state and after elapse of a first delay time from the transition to the second state occurred, the controller controls switching of the first relay from the off state to the on state, and after elapsed of a second delay longer than the first delay from the transition to the second state of the first interlock switch, controls switching of the second relay from the off state to the on state.

### BACKGROUND

### Field of the Technology

The present disclosure relates to a power supply apparatus including an interlock function and an image forming apparatus.

### Description of the Related Art

An interlock switch stops the supply of power from a power supply unit to a region to be protected when a member (for example, a door or drawer) provided at the entrance of the region to be protected is opened. However, an inrush current may flow into the power supply unit when the member is closed, causing the interlock switch to switch from off to on. Japanese Patent Laid-Open No. 2006-058509 discusses a power supply unit that starts up after a certain delay time has passed from when the interlock switch was switched on. This can suppress the inrush current caused by the switching between off and on of the interlock switch.

An image forming apparatus includes multiple loads of different characteristics such as a motor, a heater, and the like. A plurality of power supply units (for example, an alternating current to direct current (AC/DC) conversion circuit and a DC/DC conversion circuit) for generating a plurality of different DC voltages from an AC voltage supplied from a commercial power supply are required to drive these loads. Japanese Patent Laid-Open No. 2006-058509 discusses the number of power supply units controlled by the interlock switch being limited to one. Thus, in a case where a plurality of power supply units are connected to an interlock switch, Japanese Patent Laid-Open No. 2006-058509 cannot suppress inrush current.

### SUMMARY

An aspect of the present disclosure provides a power supply apparatus that includes a first power supply unit configured to be supplied with an alternating current (AC) power from an AC power supply; a second power supply unit configured to be supplied with the AC power; a first relay connected between the AC power supply and an input of the first power supply unit, wherein in an on state the AC power is supplied to the first power supply unit and an off state the AC power is not supplied to the first power supply unit; a second relay connected between the AC power supply and an input of the second power supply unit, wherein in an on state the AC power is supplied to the second power supply unit and in an off state the AC power is not supplied to the second power supply unit; a first interlock switch configured to transition between a first state when a predetermined first interlock condition is satisfied and a second state when the predetermined first interlock condition is not satisfied; and a controller. When the first interlock switch transitions from the second state to the first state, the controller is configured to control switching of the first relay from the on state to the off state and the second relay from the on state to the off state. When the first interlock switch transitions from the first state to the second state and after elapse of a first delay from the transition to the second state occurred, the controller is configured to control switching of the first relay from the off state to the on state, and after elapsed of a second delay longer than the first delay from the transition to the second state of the first interlock switch, switching of the second relay from the off state to the on state.

Features of the present disclosure will become apparent from the following description of embodiments with reference to the attached drawings.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram describing an image forming apparatus.

FIG. 2 is a diagram describing a power supply apparatus.

FIG. 3 is a diagram describing an image forming apparatus.

FIG. 4 is a diagram describing an image forming apparatus.

FIGS. 5A and 5B are diagrams describing startup operations.

FIG. 6 is a diagram describing an interlock operation.

FIG. 7 is a diagram describing functions of a central processing unit (CPU).

FIG. 8 is a flowchart illustrating a control method.

FIG. 9 is a diagram describing a power supply apparatus.

FIGS. 10A and 10B are diagrams describing a startup operation and an interlock operation.

FIG. 11 is a diagram describing functions of a CPU.

FIG. 12 is a flowchart illustrating a control method.

FIG. 13 is a diagram describing relay control between a plurality of modules.

FIG. 14 is a diagram describing a power supply apparatus.

FIGS. 15A and 15B are diagrams describing a startup operation and an interlock operation.

FIG. 16 is a diagram describing the functions of a CPU.

FIG. 17 is a flowchart illustrating a control method.

FIG. 18 is a diagram describing a modification example.

### DESCRIPTION OF THE EMBODIMENTS

Hereinafter, embodiments will be described in detail with reference to the attached drawings. The following embodiments are not intended to limit the scope of the claims. Multiple features described in the embodiments are not all required, and multiple such features may be combined as appropriate. In the attached drawings, the same reference numerals are given to the same or similar configurations, and redundant description thereof is omitted.

### Embodiment 1

### 1. Image Forming Apparatus (Image Forming System)

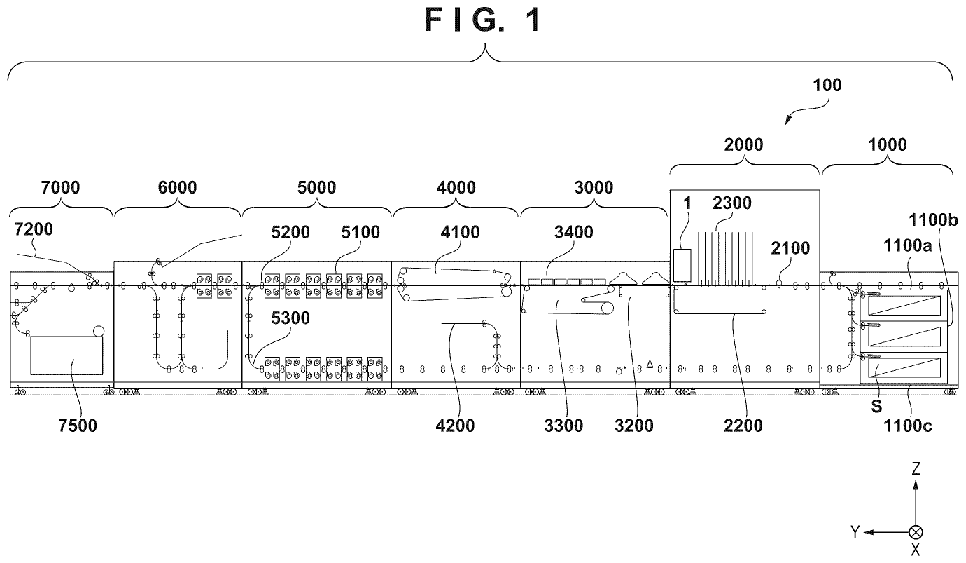

FIG. 1 is a schematic view illustrating an example of a general configuration of an image forming apparatus 100. The Z direction corresponds to a vertical direction of the image forming apparatus 100. The Y direction is substantially parallel with a sheet conveyance direction. The X direction corresponds to a width direction of a sheet S. The width direction of the sheet S may be referred to as the main scan direction. The direction parallel with the conveyance direction of the sheet S may be referred to as the sub-scan direction.

The image forming apparatus 100 is a single sheet processing image forming apparatus that forms an ink image on the sheet S using two solutions, a reaction solution and ink. The sheet S where an ink image is formed may be referred to a printed material, an output material, or a product. The ink contains, for example, a resin component, water, a water-soluble organic solvent, a color material, wax, and an additive, as an example.

The image forming apparatus 100 includes a feeding module 1000, a printing module 2000, a drying module 3000, a fixing module 4000, a cooling module 5000, an inverting module 6000, a discharge and stacking module 7000, and the like. The sheet S with a cut sheet shape supplied from the feeding module 1000 is conveyed along a conveyance path, subjected to processing at each module, and is discharged to the discharge and stacking module 7000.

The feeding module 1000 includes three storage containers 1100a to 1100c for storing one of more sheets S. The storage containers 1100a to 1100c can be pulled out to the front side of the image forming apparatus 100. The sheets S are feed one at a time by a separation belt and a conveyance roller at the storage containers 1100a to 1100c and convey to the printing module 2000. The number of the storage containers 1100a to 1100c may be one or more.

The printing module 2000 includes a sheet correction unit 2100, a belt unit 2200, and a printing unit 2300. The sheet correction unit 2100 corrects the skew and position of the sheet S conveyed from the feeding module 1000 and conveys the sheet S to the belt unit 2200. The printing unit 2300 is disposed on the opposite side of the conveyance path from the belt unit 2200. The printing unit 2300 performs a printing process (printing) to form an image on the sheet S using a print head from above the conveyed sheet S. The sheet S is conveyed while adhering to the belt unit 2200. In this manner, an appropriate clearance can be ensured between the print head and the sheet S. Also, a plurality of print heads may be arranged in the conveyance direction. In this embodiment example, four line-type print heads corresponding to ink of four colors (Y or yellow, M or magenta, C or cyan, and Bk or black) and one line-type print head that discharges a reaction solution C0 are provided. The number of colors and print heads are not limited to five. For example, three line-type print heads for special colors C1, C2, and C3, which are different from Y, M, C, and Bk may be added. Examples of inkjet printing methods include, for example, a method using a heating element, a method using a piezo element, a method using an electrostatic element, and a method using a MEMS element. MEMS is an abbreviation for micro-electro-mechanical system.

Each ink of the four colors is supplied from an ink tank to the print head via an ink tube. The belt unit 2200 conveys the sheet S where an image was printed by the printing unit 2300 disposed further downstream. An inline scanner 1 may be disposed downstream from the printing unit 2300. The inline scanner 1 detects for misalignment and the color density of the image formed on the sheet S. The detection result is used in the subsequent correction of the printed image.

The drying module 3000 reduces the liquid content included in the ink applied on the sheet S by the printing unit 2300 to increase the fixability of the ink to the sheet S. The drying module 3000 includes a decoupling unit 3200, a drying belt unit 3300, and a hot air blowing unit 3400. The sheet S printed with an image by the printing unit 2300 of the printing module 2000 is conveyed to the decoupling unit 3200 disposed inside the drying module 3000. The decoupling unit 3200 conveys the sheet S further downstream while holding the sheet S against the belt via friction with the belt and wind pressure from above. This reduces misalignment of the sheet S on the belt unit 2200. The sheet S is conveyed from the decoupling unit 3200 to the drying belt unit 3300. The drying belt unit 3300 conveys the sheet S while it is adhered. The hot air blowing unit 3400 is disposed above the drying belt unit 3300. The hot air blowing unit 3400 applies hot air to the sheet S and dries the ink-applied surface of the sheet S. The drying belt unit 3300 conveys the sheet S to the fixing module 4000.

The drying module 3000 heats the reaction solution and the liquid component of the ink applied to the sheet S to dry it. In this manner, evaporation of the reaction solution and the water content in the ink is accelerated, suppress cockling in the sheet S.

It is sufficient that the drying module 3000 is an apparatus that can perform heating and drying. For example, the drying module 3000 may include a hot air dryer or a heater. The type of heater is not particularly limited. For example, an electric wire heater or an infrared heater may be used as the heater.

The fixing module 4000 includes a fixing belt unit 4100. The fixing belt unit 4100 includes an upper belt unit and a lower belt unit. The upper belt unit and the lower belt unit are heated, and the sheet S is passed between them. In this manner, the ink solvent sufficiently permeates into the sheet S.

The cooling module 5000 includes a plurality of cooling units 5100 for cooling the high-temperature sheet S conveyed from the fixing module 4000. Each cooling unit 5100, for example, uses a fan to take outside air into a cooling box, increases the pressure inside the cooling box, and blows air to the sheet S from a nozzle formed on a conveying guide. This cools the sheet S. The cooling units 5100 are disposed on both sides of the conveyance path in the vertical direction. Accordingly, both sides of the sheet S are cooled. A switching unit 5200 that switches the conveyance path may be provided inside the cooling module 5000. The switching unit 5200 switches between conveying the sheet S to the inverting module 6000 and conveying the sheet S to a double-sided conveyance path used when performing double-sided printing. When double-sided printing is performed, the sheet S is conveyed to a double-sided conveyance path 5300 provided below the cooling module 5000. Also, the sheet S is conveyed to the fixing module 4000, the drying module 3000, the printing module 2000, and the feeding module 1000. In this manner, the sheet S is again conveyed to the sheet correction unit 2100, the belt unit 2200, and the printing unit 2300 of the printing module 2000. Then, the printing unit 2300 prints an image on the second side of the sheet S.

An inverting unit 4200 that front/back inverts the sheet S may be provided on the double-sided conveyance path of the fixing module 4000. The inverting module 6000 also includes an inverting unit 6400. The inverting unit 6400 front/back inverts the conveyed sheet S. Accordingly, the front or back (face down or face up) of the discharged sheet S can be freely selected.

The discharge and stacking module 7000 includes a top tray 7200 and a stacking unit 7500. At the top tray 7200 and the stacking unit 7500, the sheets S that are conveyed from the inverting module 6000 are aligned and stacked.

### 2. Power Supply Apparatus

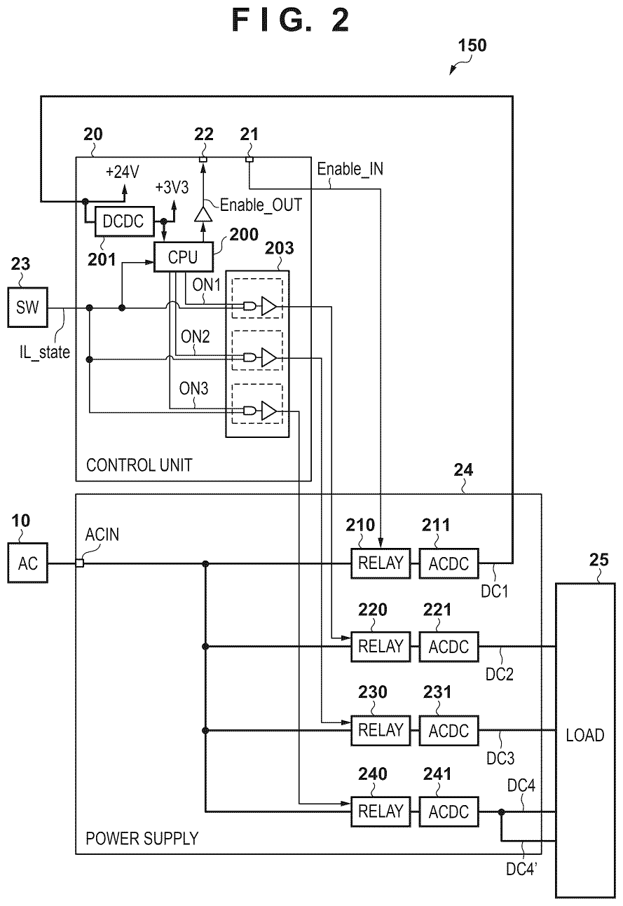

FIG. 2 illustrates a power supply apparatus 150 that can be installed in each module of the image forming apparatus 100. The power supply apparatus 150 includes a power supply 24 and a control unit 20. The power supply 24 includes AC/DC conversion units 211, 221, 231, and 241 as a plurality of power supply units, with AC being an abbreviation for alternating current, and DC being an abbreviation for direct current. The AC/DC conversion units 211, 221, 231, and 241 are each a conversion circuit that converts alternating current input from an ACIN terminal connected to an AC power supply 10 into a predetermined direct current. The AC power supply 10 is a commercial AC power supply, for example. The AC/DC conversion units 211, 221, 231, and 241 each generate a desired DC voltage DC1, DC2, DC3, and DC4. Note that the power supply lines and wiring lines for supplying the loads (the control unit 20 and a load 25) with the DC voltage DC1, DC2, DC3, and DC4 may be referred to as power supply systems DC1, DC2, DC3, and DC4. Thus, DC1, DC2, DC3, and DC4 are signs that indicate a DC voltage and a power supply system. A relay 210 is provided between the AC power supply 10 and an input unit of the AC/DC conversion unit 211. A relay 220 is provided between the AC power supply 10 and an input unit of the AC/DC conversion unit 221. A relay 230 is provided between the AC power supply 10 and an input unit of the AC/DC conversion unit 231. A relay 240 is provided between the AC power supply 10 and an input unit of the AC/DC conversion unit 241. The DC voltage DC1 generated by the AC/DC conversion unit 211 is applied to the control unit 20. The DC voltages DC2, DC3, and DC4 are supplied to the load 25. In Embodiment 1, the DC voltage of four systems is generated from the AC power supply 10 of one system, as an example. As described below, each alternating current from the plurality of AC power supplies may be input to the power supply 24. As with DC voltage DC4', one power supply system may branch into a plurality of power supply systems. At this time, the DC voltage DC4 and the DC voltage DC4′ may be equal or different. In the case of the latter, a DC/DC converter for converting the DC voltage DC4 into the DC voltage DC4′ may be required.

The relays 210, 220, 230, and 240 are an electromagnetic relay, a TRIAC, or a field effect transistor controlled by a control signal output from the control unit 20. The relays 210, 220, 230, and 240 each permit (supply or passage through) or prohibit (non-supply or cutoff) input of an alternating current to the corresponding AC/DC conversion units 211, 221, 231, and 241.

The power supply system DC1 of Embodiment 1 is a +24 V power supply. A +24 V power supply means a DC voltage of +24 V. The control unit 20 operates by being supplied with the +24 V power supply. An input terminal 21 supplies an Enable_IN signal from a controller 30 or another module. In Embodiment 1, the Enable_IN signal is a control signal (module startup permission signal) of the relay 210. When the Enable_IN signal is input to the relay 210, the relay 210 transitions from off to on, and an alternating current is input to the AC/DC conversion unit 211. The AC/DC conversion unit 211 generates the DC voltage DC1 from the alternating current and supplies the DC voltage DC1 (+24 V) to the control unit 20. The +24 V power supply is used as a power supply for driving the relays 210, 220, 230, and 240. The +24 V power supply is also used as a power supply for generate an Enable_OUT signal. An output terminal 22 is connected to the input terminal 21 of another module and supplies the Enable_OUT signal to another module.

A DC/DC conversion unit 201 generates a +3V3 power supply from the +24 V power supply and supplies the +3V3 power supply to a CPU 200. A +3V3 power supply means a DC voltage of +3.3 V. In other words, the +3V3 power supply provides the operating voltage for the CPU 200, with the numerical value for these voltages provided as examples.

The CPU 200 controls the relays 210, 220, 230, and 240 via a relay drive unit 203. The relay drive unit 203 may include a transistor or thyristor for supplying current to each relay coil of the relays 210, 220, 230, and 240. The relay coil is an electromagnetic coil that brings together or separates two contact points. One of the terminals of the relay coil is referred to as the high side and is connected to the +24 V power supply. The other terminal of the relay coil is referred to as the low side and is connected to the ground (GND).

A door switch 23 is an interlock switch attached to a maintenance door of the image forming apparatus 100. In a case where an interlock condition is satisfied (for example, the maintenance door is open or a sheet cassette is open), the door switch 23 enters a first state (open state, off state, low state). In a case where an interlock condition is not satisfied (for example, the maintenance door is closed or a sheet cassette is closed), the door switch 23 enters a second state (closed state, on state, high state). An IL_st signal indicates the state of the door switch 23 is input to the relay drive unit 203 and the CPU 200. In a case where the IL_st signal indicates that the door is open, the relay drive unit 203 cuts off the relays 220, 230, and 240. The CPU 200 monitors the state of the door switch 23 on the basis of the IL_st signal. In a case where the logical product of the state of the door switch 23 and the state of the relay control signal from the CPU 200 is true, the relay drive unit 203 allows a current to flow through the corresponding relay. In other words, the CPU 200 can forcibly turn off the relays 220, 230, and 240 independently of the state of the door switch 23.

The IL_st signal indicating the state of the door switch 23 and its connection relationship will now be schematically represented. For example, the +24 V power supply may be connected to the CPU 200 via the door switch 23 and a DC/DC converter. In this case, one end of the door switch 23 is connected to the +24 V power supply, and the other end of the door switch 23 is connected to the input terminal of the DC/DC converter. When the door is closed and the door switch 23 is on, the DC/DC converter converts the +24 V voltage input via the door switch 23 into +3.3 V voltage and applies the +3.3 V voltage to the input port of the CPU 200. In other words, the CPU 200 may use the +3V3 power supply (+3.3 V voltage) originating at the door switch 23 as the IL_st signal. The DC/DC converter, for example, may be a level converter that uses a photocoupler or a field effect transistor to convert the +24 V voltage into +3.3 V voltage. For example, the +24 V voltage is applied to the gate of the N-channel field effect transistor as a control signal. Note that the +24 V voltage may be divided by a plurality of resistor elements and input into the gate. A drain is connected to the +3.3 V power supply via a pull-up resistor. The connection point between the pull-up resistor and the drain is connected to the input port of the CPU 200. The source is connected to ground (GND).

To reduce chattering in the IL_st signal that comes with opening and closing the door, a chatter reducing circuit may be provided at the door switch 23. The chatter reducing circuit operates to stop the changes in the input signal over a short period of time being reflected in the output signal. The chatter reducing circuit, for example, may be a low-pass filter circuit formed of a resistor and a capacitor. The CPU 200 may reduce chattering via software processing. For example, the CPU 200 can reduce the effects of chattering by ignoring changes in the input signal over a short period of time.

The relay drive unit 203 will now also be schematically represented in a similar manner. For example, the relay drive unit 203 may include a transistor for controlling the high side and the low side of the relays 220, 230, and 240. The transistor switches between an on state where the +24 V power supply is applied to the relay coil and an off state where the +24 V power supply is not applied to the relay coil. In this manner, the opening and closing of the relays 220, 230, and 240 may be controlled.

The CPU 200 outputs the Enable_OUT signal to the output terminal 22 at a timing according to a control program. According to FIG. 2, the load 25 is a DC load, but an AC load may also exist. The AC load is supplied with an alternating current input from the AC power supply 10 via only the relay and not via the AC/DC conversion unit. In Embodiment 1, the CPU 200 controls the three relays 220, 230, and 240, as an example, with the number of relays being at least one.

### 3. Connection Between Modules

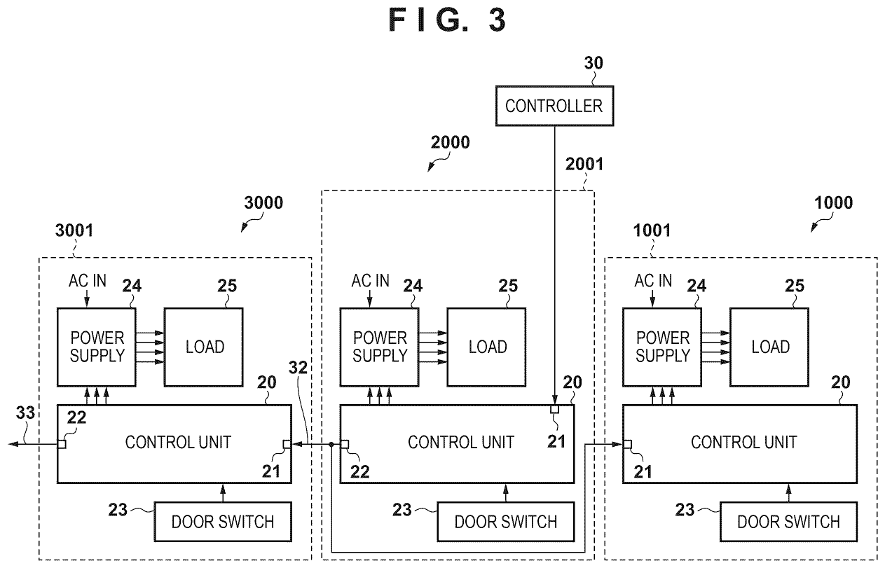

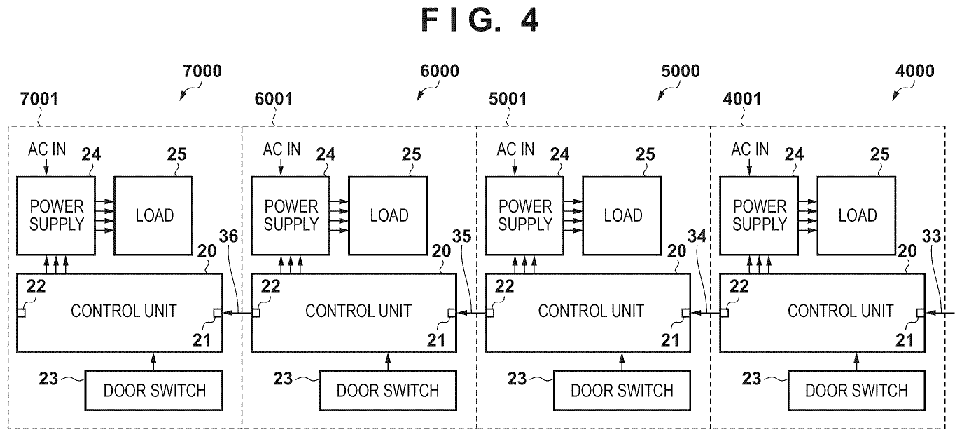

FIGS. 3 and 4 illustrate the power supply connections between the plurality of modules. The feeding module 1000 includes a casing 1001 that houses the power supply apparatus 150. The printing module 2000 includes a casing 2001 that houses the power supply apparatus 150. The drying module 3000 includes a casing 3001 that houses the power supply apparatus 150. The fixing module 4000 includes a casing 4001 that houses the power supply apparatus 150. The cooling module 5000 includes a casing 5001 that houses the power supply apparatus 150. The inverting module 6000 includes a casing 6001 that houses the power supply apparatus 150. The discharge and stacking module 7000 includes a casing 7001 that houses the power supply apparatus 150. In this manner, each module includes the power supply apparatus 150 and the load 25. In varied embodiments, two or more of the modules may include door switch 23 or the control unit 21 of each module may receive an input from one or more door switches provided outside of the module. The controller 30 comprehensively controls the entire image forming apparatus 100. The controller 30 may be provided outside of the power supply apparatus 150.

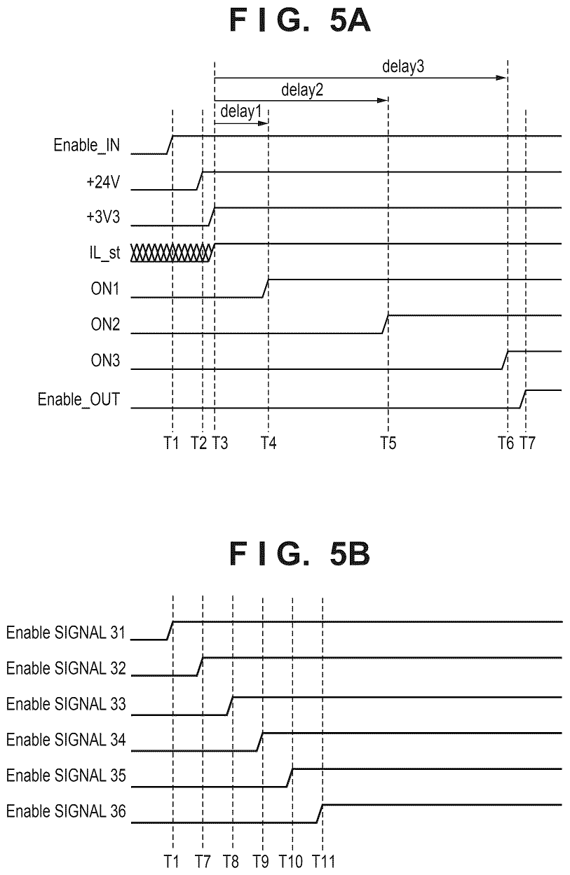

The controller 30 generates an Enable signal 31 (FIG. 5B) for starting up the image forming apparatus 100. The Enable signal 31 is input to the input terminal of the printing module 2000. In Embodiment 1, Enable signals 31 to 36 are startup permission signals, which are a type of control signal. The Enable signal 31 functions as the Enable_IN signal. Accordingly, the control unit 20 of the printing module 2000 is started up when the relay 210 of the printing module 2000 is turned on and generation of a +24 V power supply is started.

When the printing module 2000 starts up, the Enable signal 32 is output from the output terminal 22 of the printing module 2000 as the Enable_OUT signal. The Enable signal 32 is input, as the Enable_IN signal, to the input terminal 21 of the feeding module 1000 and the input terminal 21 of the drying module 3000. Accordingly, the relay 210 of the feeding module 1000 is turned on, and the control unit 20 of the feeding module 1000 starts up. In a similar manner, the relay 210 of the drying module 3000 is turned on, and the control unit 20 of the drying module 3000 starts up.

When the drying module 3000 starts up due to the Enable signal 32, the control unit 20 of the drying module 3000 outputs the Enable signal 33 from the output terminal 22. The Enable signal 33 is input, as the Enable_IN signal, the input terminal 21 of the fixing module 4000. Accordingly, the relay 210 of the fixing module 4000 is turned on, and the control unit 20 of the fixing module 4000 starts up.

When the fixing module 4000 starts up due to the Enable signal 33, the control unit 20 of the fixing module 4000 outputs the Enable signal 34 from the output terminal 22. The Enable signal 34 is input, as the Enable_IN signal, the input terminal 21 of the cooling module 5000. Accordingly, the relay 210 of the cooling module 5000 is turned on, and the control unit 20 of the cooling module 5000 starts up.

When the cooling module 5000 starts up due to the Enable signal 34, the control unit 20 of the cooling module 5000 outputs the Enable signal 35 from the output terminal 22. The Enable signal 35 is input, as the Enable_IN signal, the input terminal 21 of the inverting module 6000. Accordingly, the relay 210 of the inverting module 6000 is turned on, and the control unit 20 of the inverting module 6000 starts up.

When the inverting module 6000 starts up due to the Enable signal 35, the control unit 20 of the inverting module 6000 outputs the Enable signal 36 from the output terminal 22. The Enable signal 36 is input, as the Enable_IN signal, the input terminal 21 of the discharge and stacking module 7000. Accordingly, the relay 210 of the discharge and stacking module 7000 is turned on, and the control unit 20 of the discharge and stacking module 7000 starts up.

In this manner, each module is sequentially started up by the Enable signals 31 to 36 originating at the controller 30. In Embodiment 1, the input order of the Enable signals 31 to 36 with the printing module 2000 being first input with the Enable signal 31 as an example. According to FIGS. 3 and 4, each module includes an individual ACIN terminal which is connected to the AC power supply 10, as an example. A single ACIN terminal may be shared by a plurality of modules.

### 4. Timing Chart

### 4.1 Startup Operation of Each Module

FIG. 5A is a timing chart illustrating the startup operation. Here, it is assumed that the door switch 23 is in the on state (door closed state).

At time T1, the Enable_IN signal is input to the input terminal 21. At time T2, the relay 210 is turned on due to the Enable_IN signal, and the AC/DC conversion unit 211 starts outputting the +24 V power supply.

At time T3, the DC/DC conversion unit 201 starts generating the +3V3 power supply. This causes the CPU 200 to start up. By the +3V3 power supply being enabled, the IL_st signal is recognized as an active input signal by the CPU 200. The logic of the IL_st signal is either Hi or Lo. Hi represents a door switch on (door closed) state. Lo represents a door switch off (door open) state.

Time T4 is the time when a delay time delay1 has passed from the startup time (time T3). At time T4, the CPU 200 asserts an ON1 signal for turning the relay 220 on. Accordingly, the AC/DC conversion unit 221 starts up and starts generating the DC voltage DC2.

Time T5 is the time when a delay time delay2 has passed from the startup time (time T3). At time T5, the CPU 200 asserts an ON2 signal for turning the relay 230 on. Accordingly, the AC/DC conversion unit 231 starts up and starts generating the DC voltage DC3.

Time T6 is the time when a delay time delay3 has passed from the startup time (time T3). At time T6, the CPU 200 asserts an ON3 signal for turning the relay 240 on. Accordingly, the AC/DC conversion unit 241 starts up and starts generating the DC voltage DC4.

At time T7, the CPU 200 determines that turning on all of the relays 220, 230, and 240 has been completed and asserts the Enable_OUT signal. Accordingly, generation of the +24 V power supply of the later stage modules is started, and the later stage modules are started up.

### 4.2 Startup Operation of Image Forming Apparatus

FIG. 5B illustrates the timing of the asserting of the Enable signals 31 to 36. Time T1 and time T7 correspond with time T1 and time T7 illustrated in FIG. 5A.

The Enable signal 31 is input from the controller 30 to the printing module 2000 at time T1. Accordingly, the CPU 200 of the printing module 2000 sequentially turns on the relays 220, 230, and 240 of the printing module 2000.

At time T7, the CPU 200 of the printing module 2000 asserts the Enable signal 32 for the later stage drying module 3000 and the feeding module 1000. Accordingly, the drying module 3000 and the feeding module 1000 both start up. Note that the printing module 2000 may be referred to as a higher level module, and the drying module 3000 and the feeding module 1000 may be referred to as a lower level module. The higher level module starts up before the lower level module, and the lower level module starts up after the higher level module. In this manner, higher level and lower level may indicate the startup priority order and startup hierarchical relationship. The higher level module may be referred to as earlier stage module, and the lower level module may be referred to as a later stage module.

At time T8, the CPU 200 of the drying module 3000 asserts the Enable signal 33 for the later stage fixing module 4000. This causes the fixing module 4000 to start up. Here, the drying module 3000 is a higher level module, and the fixing module 4000 is a lower level module.

At time T9, the CPU 200 of the fixing module 4000 asserts the Enable signal 34 for the later stage cooling module 5000. This causes the cooling module 5000 to start up.

At time T10, the CPU 200 of the cooling module 5000 asserts the Enable signal 35 for the later stage inverting module 6000. This causes the inverting module 6000 to start up.

At time T11, the CPU 200 of the inverting module 6000 asserts the Enable signal 36 for the later stage discharge and stacking module 7000. This causes the discharge and stacking module 7000 to start up.

As illustrated in FIG. 5A, since the AC/DC conversion units 221, 231, and 241 start up in order, the inrush current is reduced. As illustrated in FIG. 5A, since the plurality of modules start up in order, the inrush current is reduced.

### 4.3 Interlock Operation

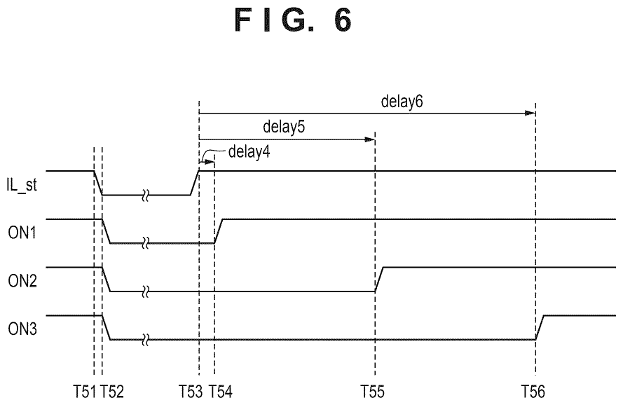

FIG. 6 illustrates the interlock operation of the CPU 200 according to the state of the door switch 23. At time T51, the door is opened and the door switch 23 is turned off. Accordingly, the IL_st signal is negated.

At time T52, the CPU 200 detects that the IL_st signal has been negated. The CPU 200 negates all of the ON1 signal, the ON2 signal, and the ON3 signal.

At time T53, the door is closed and the door switch 23 is turned on. Accordingly, the IL_st signal is asserted.

Time T54 is the time when a predetermined delay time delay4 has passed from time T53. At time T54, the CPU 200 asserts the ON1 signal.

Time T55 is the time when a predetermined delay time delay5 has passed from time T53. At time T55, the CPU 200 asserts the ON2 signal. The delay time delay5 may be measured from time T54.

Time T56 is the time when a predetermined delay time delay6 has passed from time T53. At time T56, the CPU 200 asserts the ON3 signal. The delay time delay6 may be measured from time T55.

At time T53, even if the door switch 23 is on, the CPU 200 negates the ON1 signal to the ON3 signal. Thus, the relay drive unit 203 does not turn on the relays 220, 230, and 240 under its control. In practice, since the relays 220, 230, and 240 are turned on, the door switch 23 needs to be turned on and the ON1 signal to the ON3 signal needs to be asserted. In other words, the relays 220, 230, and 240 turn on at time T54, T55, and T56, respectively. The relays 220, 230, and 240 turn on with a delay from the timing of when the door switch 23 is turned on.

The delays 1 to 3 may match or be different to the delays 4 to 6, respectively. The delays 1 to 3 may be the same value or different values. The delays 4 to 6 may be the same value or different values.

### 5. CPU Function

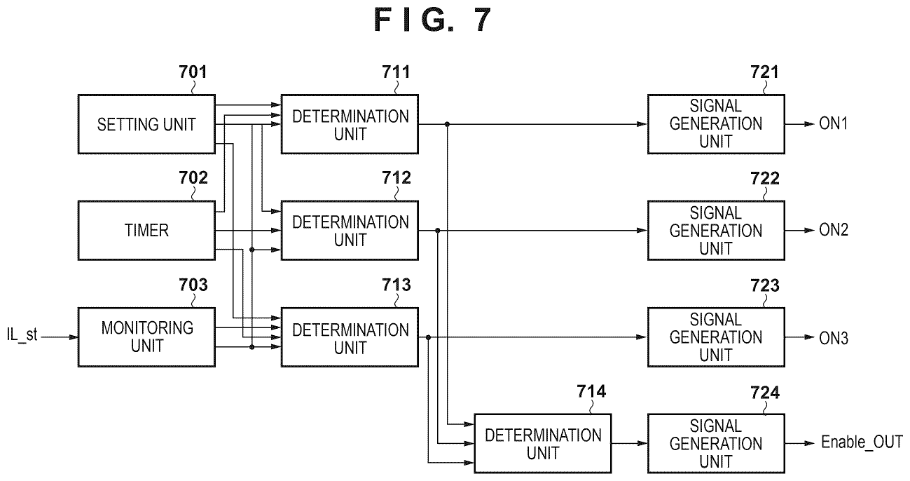

FIG. 7 illustrates a plurality of functions implemented by the CPU 200 executing a control program. One or two or more functions of the plurality of functions may be implemented by a logic circuit (for example, a transistor or a discrete IC). IC is an abbreviation for integrated circuit.

A setting unit 701 sets a predetermined delay time for determination units 711, 712, and 713. In a case where the delay time is a fixed value, the setting unit 701 may be omitted. A timer 702 is used to measure the time via a real time clock, a counter circuit, or the like. A monitoring unit 703 monitors the IL_st signal and obtains the state of the door switch 23. In other words, the monitoring unit 703 determines whether or not the interlock condition is satisfied.

The determination unit 711 obtains the elapsed time from when the IL_st signal turned to Hi from the timer 702 and determines whether or not the elapsed time has become the delay time delay4. The determination result is output to a determination unit 714 and a signal generation unit 721. The signal generation unit 721 starts the output of the ON1 signal to the relay 220 on the basis of a determination signal indicating that the elapsed time has become the delay time delay4.

The determination unit 712 obtains the elapsed time from when the IL_st signal turned to Hi from the timer 702 and determines whether or not the elapsed time has become the delay time delay5. The determination result is output to the determination unit 714 and a signal generation unit 722. The signal generation unit 723 starts the output of the ON2 signal to the relay 230 on the basis of a determination signal indicating that the elapsed time has become the delay time delay5.

The determination unit 713 obtains the elapsed time from when the IL_st signal turned to Hi from the timer 702 and determines whether or not the elapsed time has become the delay time delay6. The determination result is output to the determination unit 714 and a signal generation unit 723. The signal generation unit 723 starts the output of the ON3 signal to the relay 220 on the basis of a determination signal indicating that the elapsed time has become the delay time delay6.

When the determination result from any of the determination units 711 to 714 indicates that the predetermined delay time has passed, the determination unit 714 commands a signal generation unit 724 to generate the Enable_OUT signal. Accordingly, the signal generation unit 724 asserts the Enable_OUT signal.

### 6. Flowchart

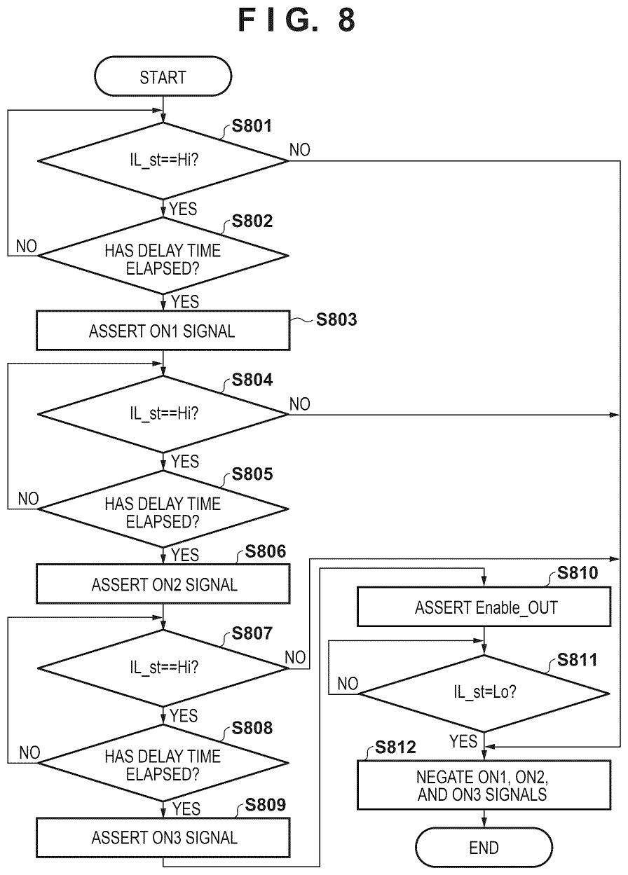

FIG. 8 illustrates a control method executed by the CPU 200 according to a control program. When the +3V3 power supply is input to the CPU 200, the CPU 200 executes the following processing.

In S801, the CPU 200 (monitoring unit 703) determines whether or not the IL_st signal is asserted. If the IL_st signal is not asserted, the CPU 200 proceeds from S801 to S812 and negates the ON1 signal. If the IL_st signal is asserted, the CPU 200 proceeds from S801 to S802.

In S802, the CPU 200 (determination unit 711) obtains the elapsed time from the timer 702 and determines whether or not the delay time delay4 has elapsed on the basis of the elapsed time. If the delay time delay4 has elapsed, the CPU 200 proceeds from S802 to S803. If the delay time delay4 has not elapsed, the CPU 200 proceeds from S802 to S801.

In S803, the CPU 200 (signal generation unit 721) asserts the ON1 signal.

In S804, the CPU 200 (monitoring unit 703) determines whether or not the IL_st signal is asserted. If the IL_st signal is not asserted, the CPU 200 proceeds from S804 to S812 and negates the ON2 signal. If the IL_st signal is asserted, the CPU 200 proceeds from S804 to S805.

In S805, the CPU 200 (determination unit 712) obtains the elapsed time from the timer 702 and determines whether or not the delay time delay5 has elapsed on the basis of the elapsed time. If the delay time delay5 has elapsed, the CPU 200 proceeds from S805 to S806. If the delay time delay5 has not elapsed, the CPU 200 proceeds from S805 to S804.

In S806, the CPU 200 (signal generation unit 722) asserts the ON2 signal.

In S807, the CPU 200 (monitoring unit 703) determines whether or not the IL_st signal is asserted. If the IL_st signal is not asserted, the CPU 200 proceeds from S807 to S812 and negates the ON3 signal. If the IL_st signal is asserted, the CPU 200 proceeds from S807 to S808.

In S808, the CPU 200 (determination unit 713) obtains the elapsed time from the timer 702 and determines whether or not the delay time delay6 has elapsed on the basis of the elapsed time. If the delay time delay6 has elapsed, the CPU 200 proceeds from S808 to S809. If the delay time delay6 has not elapsed, the CPU 200 proceeds from S808 to S807.

In S809, the CPU 200 (signal generation unit 723) asserts the ON3 signal.

In S810, the CPU 200 (determination unit 714, signal generation unit 724) asserts the Enable_OUT signal.

In S811, the CPU 200 (monitoring unit 703) determines whether or not the IL_st signal is asserted. If the IL_st signal is not asserted, the CPU 200 proceeds from S811 to S812 and negates the ON1, ON2, and ON3 signals. If the IL_st signal is asserted, the CPU 200 stops at S811.

According to Embodiment 1, the CPU 200 monitors the state of the door switch 23, and if the door switch 23 is in the off state (door open), the CPU 200 negates the ON1, ON2, and ON3 signals to the relays 220, 230, and 240. If the door switch 23 is in the on state (door open), the relays 220, 230, and 240 turn on at different times. In other words, the ON1, ON2, and ON3 signals are asserted in order according to the different delay times.

This helps stop the relays 220, 230, and 240 from simultaneously being turned on when the door switch 23 is restored to the on state from the off state. As a result, an inrush current from the AC power supply 10 to the AC/DC conversion units 221, 231, and 241 is reduced.

In Embodiment 1, the relays 220, 230, and 240 are examples of a first relay, a second relay, and a third relay. The AC/DC conversion units 221, 231, and 241 are examples of a first power supply unit, a second power supply unit, and third power supply unit. In Embodiment 1, when the door is closed, the first interlock switch (for example, door switch 23) transitions from the first state to the second state. As a result, when a first delay time (for example, delay4) from the time of the transition to the second state has elapsed, the relay 220 is switched from the off state to the on state. When a second delay time (for example, delay5) longer than the first delay time from the time of the transition to the second state has elapsed, the relay 230 is switched from the off state to the on state. Also, when a third delay time (for example, delay6) longer than the second delay time from the time of the transition to the second state has elapsed, the relay 240 is switched from the off state to the on state. In Embodiment 1, an Enable signal output by an earlier stage module acts as the startup permission signal for a later stage module. The startup permission signal may be output after at least the first relay and the second relay have each switched from off to on. Alternatively, the startup permission signal may be output after at least the first relay, the second relay, and the third relay have each switched from off to on. In Embodiment 1, the Enable signal (Enable_OUT, Enable_IN) is used as the startup permission signal for the control unit 20. The startup of each module is controlled by a startup permission signal.

As can be seen from FIGS. 3 and 4, each module includes the power supply apparatus 150 illustrated in FIG. 2. By the modules starting up in order via an Enable signal, an inrush current to the image forming apparatus 100 overall is reduced. In other words, in Embodiment 1, not only is an inrush current to the power supply apparatus 150 reduced, but an inrush current to the image forming apparatus 100 overall is reduced.

### Embodiment 2

In Embodiment 1, an output from the single door switch 23 is provided to each module of the image forming apparatus 100, as an example. In Embodiment 2, a case in which a plurality of door switches exist will be described, with the plurality of door switches provided on doors of one or more of the feeding module 1000, the printing module 2000, the drying module 3000, the fixing module 4000, the cooling module 5000, the inverting module 6000 and the discharge and stacking module 7000. A method for reducing inrush current that comes with opening and closing a door across a plurality of modules will also be described.

In particular, in Embodiment 2, each module turns on the relays 220, 230, and 240 according to an internal control cycle of a constant interval. Also, in Embodiment 2, the timings of when the relays are turned on are made to not overlap between modules by offsetting the internal control cycle of each module.

### 1. Power Supply Apparatus

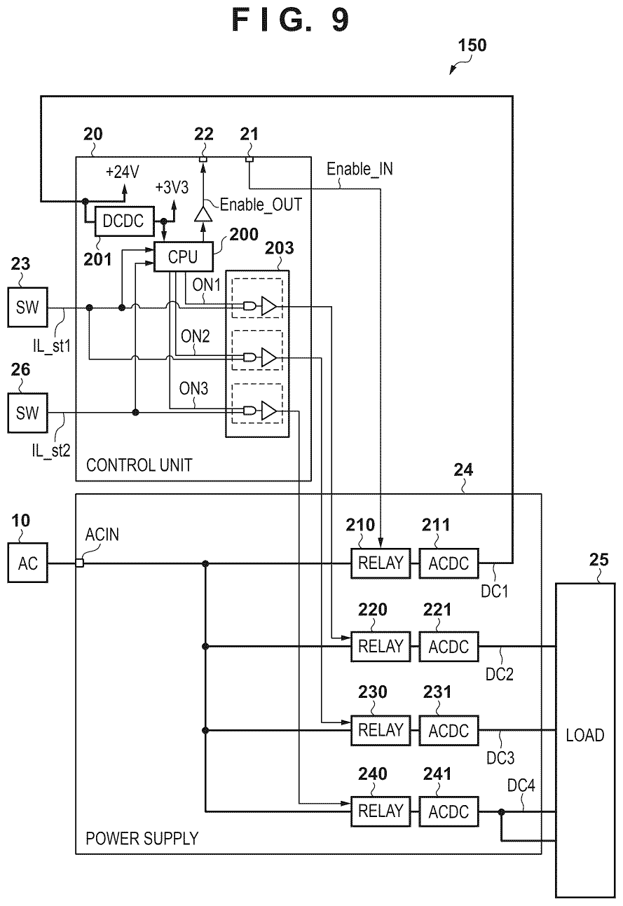

FIG. 9 illustrates the power supply apparatus 150 that can be installed in each module of Embodiment 2. The difference between Embodiment 1 and Embodiment 2 is that the power supply system DC2 and the power supply system DC3 form an interlock via the door switch 23 as well as the power supply system DC4 forming an interlock via a door switch 26. The CPU 200 monitors the state of each of the door switch 23 and the door switch 26. For example, the door switch 23 may be provided on a first freely opening and closing member, and the door switch 26 may be provided on a second freely opening and closing member. A freely opening and closing member is a maintenance door, a sheet cassette, or the like, for example. Embodiment 2 is similar to Embodiment 1 on other points. Hereinafter, the state signal of the door switch 23 will be referred to as an IL_st1 signal. The state signal of the door switch 26 will be referred to as an IL_st2 signal.

### 2. Timing Chart

### 2.1 Startup Operation

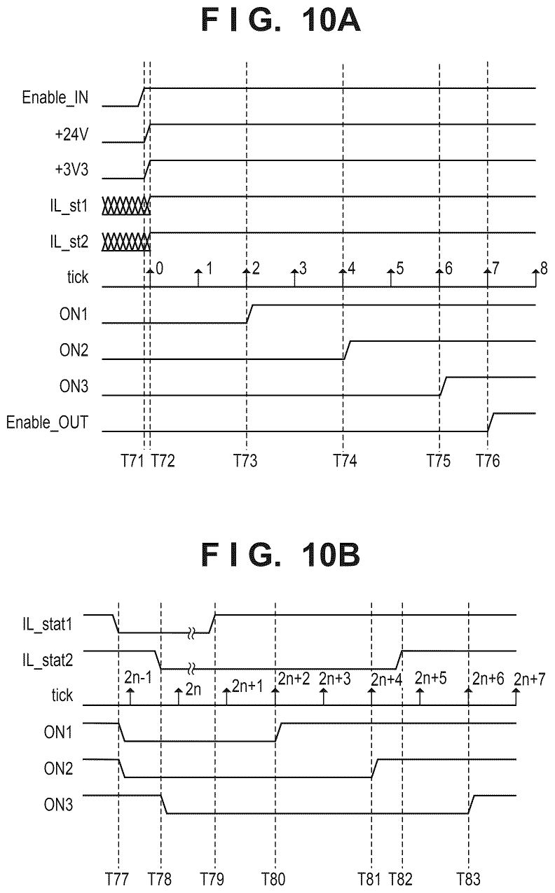

FIG. 10A illustrates the startup operation of the control unit 20. At time T71, the Enable_IN signal is input to the input terminal 21. Accordingly, the relay 210 is turned on, and generation of the +24 V power supply and the +3V3 power supply is started.

At time T72, the CPU 200 starts up. The CPU 200 starts generating a constant cycle signal tick using the timer 702. In this manner, the generation of the cycle signal tick is started with input of the Enable_IN signal as the starting point. Also, the CPU 200 adds 1 to the count value each time the cycle signal tick rises. The cycle signal tick is used as the internal control cycle. The count value is used as the index of the cycle signal tick.

Time T73 is timing in sync with an even-numbered tick. The CPU 200 determines that the IL_st1 signal is asserted at time T73 and asserts the ON1 signal.

Time T74 is timing in sync with an even-numbered tick. The CPU 200 determines that the IL_st1 signal is asserted at time T74 and asserts the ON2 signal.

Time T75 is timing in sync with an even-numbered tick. At time T73, the CPU 200 determines that the IL_st2 signal is asserted at time T75 and asserts the ON3 signal.

Time T76 is timing in sync with an odd-numbered tick. The CPU 200 determines that all of the ON1 signal, the ON2 signal, and the ON3 signal are being asserted at time T76 and asserts the Enable_OUT signal.

According to Embodiment 2, the CPU 200 asserts ON signals in sync with even-numbered ticks. The CPU 200 asserts the Enable_OUT signal in sync with an odd-numbered tick. In other words, in a case where the count value is an even value, the relays 220, 230, and 240 are turned on, and in a case where the count value is an odd value, the Enable_OUT signal is asserted, as an example. In a case where the count value is an odd value, the relays 220, 230, and 240 may be turned on, and in a case where the count value is an even value, the Enable_OUT signal may be asserted. This is because these can be substituted for one another.

### 2.2 Interlock Operation

FIG. 10B illustrates an interlock operation. At time T77, the CPU 200 determines that the IL_st1 signal has been negated and negates the ON1 signal and the ON2 signal. At time T78, the CPU 200 determines that the IL_st2 signal has been negated and negates the ON3 signal. Accordingly, a plurality of the relays from among the relays 220, 230, and 240 may be simultaneously turned off.

At time T79, if the CPU 200 detects that the IL_st1 signal has been asserted, the CPU 200 waits until the next even-numbered tick. Time T80 is timing corresponding to the 2n+2-th tick. At time T80, the CPU 200 asserts the ON1 signal. n is any positive integer. Time T81 is timing corresponding to the 2n+4-th tick. At time T81, the CPU 200 asserts the ON2 signal. In this manner, the count value (for example, a second even value) for asserting of the ON2 signal is greater than the count value (for example, a first even value) for asserting of the ON1 signal.

At time T82, if the CPU 200 determines that the IL_st2 signal has been asserted and waits until the next even-numbered tick. Time T83 is timing corresponding to the 2n+6-th tick. At time T83, the CPU 200 asserts the ON3 signal. In this manner, the count value (for example, a third even value) for asserting of the ON3 signal is greater than the count value (for example, the second even value) for asserting of the ON2 signal.

In Embodiment 2, the CPU 200 is configured so that, when the count value of the internal control cycle is an even number, the relays turn on, and when the count value is an odd number, the Enable output signal is asserted. The odd-numbered internal control cycle in which the Enable_OUT signal is output corresponds to the start time of the internal control cycle for a later stage module, or in other words, an even-numbered internal control cycle. Accordingly, the timing of when a relay is turned on for a plurality of adjacent modules is dispersed and is independent of the on and off timing of the door switches 23 and 26 provided in each module. By offsetting the relay on timing between each module, the inrush current from the AC power supply 10 to the image forming apparatus 100 is reduced.

### 3. CPU Function

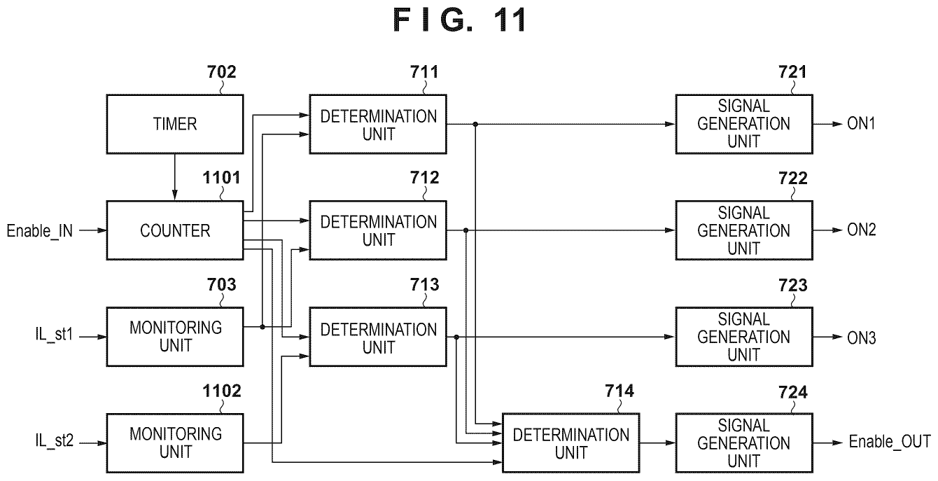

FIG. 11 illustrates the functions of the CPU 200 according to Embodiment 2. Here, the differences with Embodiment 1 will be described in detail. A counter 1101 references the timer 702 and counts the internal control cycle. In other words, the counter 1101 adds 1 to a count value each time an amount of time corresponding to the tick elapses. The counter 1101 may start the tick count with the Enable_IN signal input from an earlier stage module to the input terminal 21 acting as the starting point or trigger. In this manner, the earlier stage module can control the starting point of the internal control cycle of the later stage module.

The monitoring unit 703 monitors the state of the door switch 23 on the basis of the IL_st1 signal. The monitoring result is supplied to the determination unit 711 and the determination unit 712. When the IL_st1 signal is asserted, the determination unit 711 obtains the count value from the counter 1101 and determines whether the count value is an even number. In a case where the count value is an even number, the determination unit 711 commands the signal generation unit 721 to assert the ON1 signal. When the IL_st1 signal is asserted, the determination unit 712 obtains the count value from the counter 1101 and determines whether the count value is an even number. In a case where the count value is an even number, the determination unit 712 commands the signal generation unit 721 to assert the ON2 signal. The determination unit 712 commands the signal generation unit 721 to assert the ON2 signal after the determination unit 711.

A monitoring unit 1102 monitors the state of the door switch 26 on the basis of the IL_st2 signal. When the IL_st2 signal is asserted, the determination unit 713 obtains the count value from the counter 1101 and determines whether the count value is an even number. In a case where the count value is an even number, the determination unit 712 commands the signal generation unit 721 to assert the ON3 signal as the determination result.

When the ON1 signal to ON3 signal are all asserted, the determination unit 714 obtains the count value from the counter 1101 and determines whether the count value is an odd number. If the count value is an odd number, the determination unit 714 commands the signal generation unit 724 to assert the Enable_OUT signal.

### 4. Flowchart

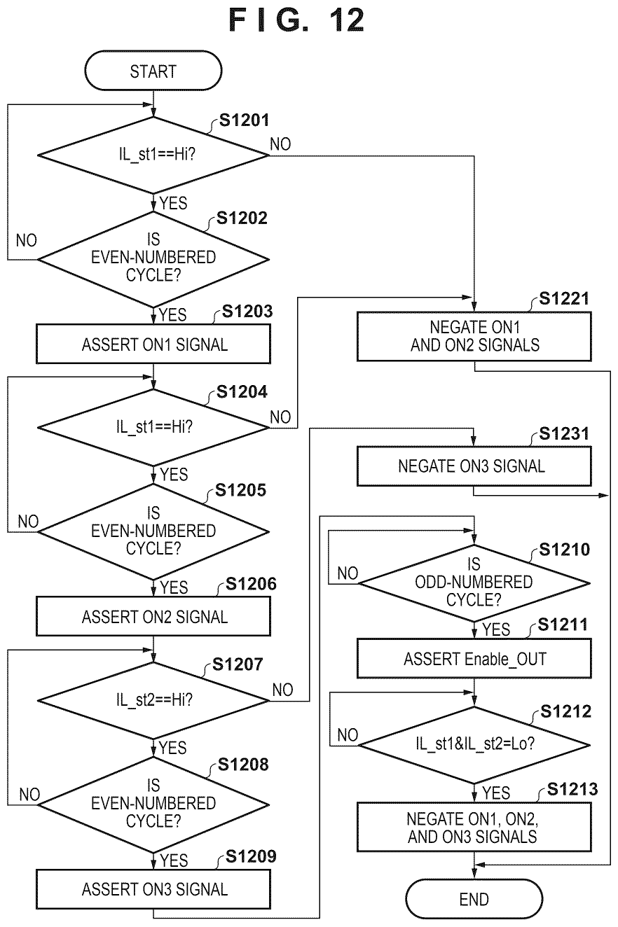

FIG. 12 illustrates a control method executed by the CPU 200 according to a control program. When the +3V3 power supply is input to the CPU 200, the CPU 200 executes the following processing. Note that the CPU 200 (counter 1101) starts the count of the internal control cycle with the Enable_IN signal input to the input terminal 21 acting as the starting point.

In S1201, the CPU 200 (monitoring unit 703) determines whether or not the IL_st1 signal is asserted. If the IL_st1 signal is not asserted, the CPU 200 proceeds from S1201 to S1221 and negates the ON1 signal. If the IL_st1 signal is asserted, the CPU 200 proceeds from S1201 to S1202.

In S1202, the CPU 200 (determination unit 711) obtains the count value from the counter 1101 and determines whether or not the count value is an even number. If the count value is an even number, the CPU 200 proceeds from S1202 to 1203. If the count value is an odd number, the CPU 200 proceeds from S1202 to S1201.

In S1203, the CPU 200 (signal generation unit 721) asserts the ON1 signal.

In S1204, the CPU 200 (monitoring unit 703) determines whether or not the IL_st1 signal is asserted. If the IL_st1 signal is not asserted, the CPU 200 proceeds from S1204 to S1221 and negates the ON2 signal. If the IL_st1 signal is asserted, the CPU 200 proceeds from S1204 to S1205.

In S1205, the CPU 200 (determination unit 712) obtains the count value from the counter 1101 and determines whether or not the count value is an even number. If the count value is an even number, the CPU 200 proceeds from S1205 to S1206. If the count value is an odd number, the CPU 200 proceeds from S1205 to S1204.

In S1206, the CPU 200 (signal generation unit 722) asserts the ON2 signal. Note that the count value for asserting the ON2 signal is greater than the count value for asserting the ON1 signal.

In S1207, the CPU 200 (monitoring unit 1102) determines whether or not the IL_st2 signal is asserted. If the IL_st2 signal is not asserted, the CPU 200 proceeds from S1207 to S1231 and negates the ON3 signal. If the IL_st2 signal is asserted, the CPU 200 proceeds from S1207 to S1208.

In S1208, the CPU 200 (determination unit 713) obtains the count value from the counter 1101 and determines whether or not the count value is an even number. If the count value is an even number, the CPU 200 proceeds from S1208 to S1209. If the count value is not an even number, the CPU 200 proceeds from S1208 to S1207.

In S1209, the CPU 200 (signal generation unit 723) asserts the ON3 signal. The count value for asserting the ON3 signal is greater than the count value for asserting the ON2 signal.

In S1210, the CPU 200 (determination unit 713) obtains the count value from the counter 1101 and determines whether or not the count value is an odd number. If the count value is an odd number, the CPU 200 proceeds from S1210 to S1211. If the count value is an odd number, the CPU 200 stops at S1210.

In S1211, the CPU 200 (determination unit 714, signal generation unit 724) asserts the Enable_OUT signal. The count value for asserting the Enable_OUT signal is greater than the count value for asserting the ON3 signal.

In S1212, the CPU 200 (monitoring unit 703) determines whether or not both the IL_st1 signal and the IL_st2 signal are negated. If both the IL_st1 signal and the IL_st2 signal are negated, the CPU 200 proceeds from S1212 to S1213 and negates the ON1, ON2, and ON3 signals. If at least one of the IL_st1 signal and the IL_st2 signal is asserted, the CPU 200 stops at S1212.

### 5. Generalization

According to the embodiment examples described above, the ON1 signal, the ON2 signal, and the ON3 signal are asserted when the count values are an even number. The Enable_OUT signal is asserted when the count value is an odd number, as an example.

For example, in a case where N number of modules exist, the CPU 200 executes N number of remainder operations (modulo operation) with respect to the count values to obtain a solution. The CPU 200 may turn on the relays 220, 230, and 240 at an internal control cycle in which the solution is a first value (for example, 0). Also, the CPU 200 may assert the Enable_OUT signal at an internal control cycle in which the solution a second value (for example, 1). The first value and the second value are different.

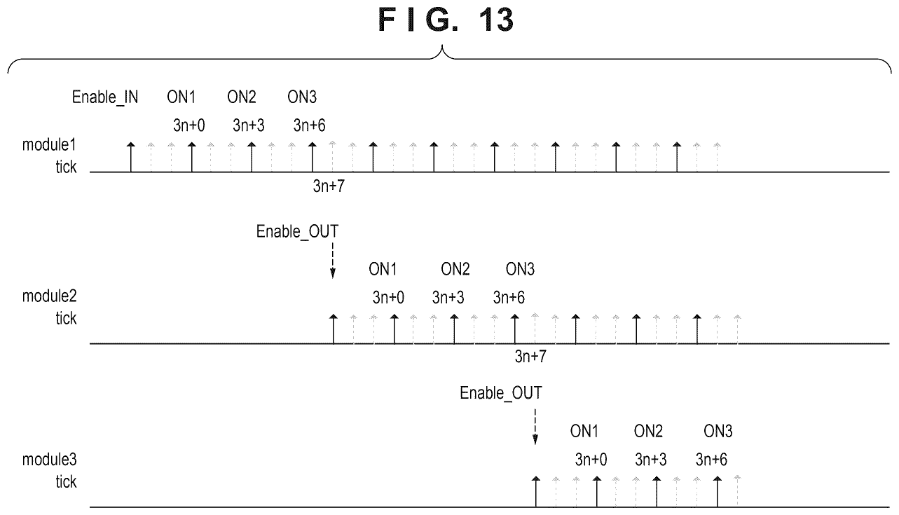

FIG. 13 illustrates the internal control cycle in a case where N is 3. Since N equals 3, it can be assumed that three modules (module1, module2, and module3) exist. The CPU 200 turns on the relays 220, 230, and 240 at an internal control cycle in which the count value is 3n+0, 3n+3, 3n+6, and so on. This indicates that the delay time between the on timing of the relay 220 and the on timing of the relay 230 is N times the internal control cycle. The delay time between the on timing of the relay 230 and the on timing of the relay 240 is also N times the internal control cycle. The CPU 200 asserts the Enable_OUT signal at each internal control cycle in which the count value is 3n+1, 3n+4, 3n+7, and so on. In FIG. 13, the Enable_OUT signal is asserted at the 3n+7-th internal control cycle, which is the first after all of the relays 220, 230, and 240 are turned on.

The 3n+1, 3n+4, and so on internal control cycles in which Enable_OUT signal is output correspond to the start timing of an internal control cycle for the later stage module. In other words, the counter 1101 of the later stage module starts the count of the internal control cycle when the Enable_OUT signal is input as the Enable_IN signal.

Accordingly, the difference between the cycle in which the relay turns on for the adjacent earlier stage module and the cycle in which the relay turns on for the adjacent later stage module is ⅓ of the internal control cycle. In other words, the timing of when the relay turns on for the earlier stage module and the timing of when the relay turns on for the later stage module do not overlap. Accordingly, the inrush current may be reduced.

The image forming apparatus 100 illustrated in FIG. 1 includes seven modules. In other words, the CPU 200 can execute modulo operation with N as 7 and offset the on timing of the relays on the basis of the solution.

According to Embodiment 2, the on timing of the relays and the output timing of the Enable_OUT signal are controlled by the CPU 200 on the basis of the count value of the internal control cycle. In this manner, the on timing of the power supply unit of a plurality of adjacent modules can be appropriately offset, reducing inrush current.

In Embodiment 2, the timing is controlled so that the timings of when a signal is asserted for a plurality of adjacent modules are different. However, this technical concept can also be applied to the power supply apparatus 150 including the plurality of door switches 23 and 26 in the same module and the corresponding plurality of power supply units. For example, when the count value is an even number, the relay 220 and the relay 230 may be turned on, and when the count value is an odd number, the relay 240 may be turned on. Generally, the relays 220 and 230 may be turned on in an internal control cycle in which the solution of the modulo operation is the first value, and the relay 240 may be turned on in an internal control cycle in which the solution is the second value.

According to Embodiment 2, the door switch 26 is an example of a second interlock switch. When switching the relays 220, 230, and 240 from off to on, different delay times are applied on the basis of the count value of the internal control cycle. For example, in a case where the count value is a first even value, the relay 220 is switched from off to on. In a case where the count value is a second even value, the relay 230 is switched from off to on. In a case where the count value is a third even value, the relay 240 is switched from off to on. The second even value is greater than the first even value. The third even value is greater than the second even value. The first even value, the second even value, and the third even value are the same, even if substituted with a first odd value, a second odd value, and a third odd value. In Embodiment 2, the starting point of the internal control cycle of the earlier stage module is offset from the starting point of the internal control cycle of the later stage module. Accordingly, the startup timings of a plurality of modules are offset from one another, allowing an inrush current to the image forming apparatus 100 to be reduced. An Enable signal may be used to offset the starting point of the internal control cycle of the earlier stage module and the starting point of the internal control cycle of the later stage module. The Enable signal is output when the count value is an odd value. In a case where the relays 220, 230, and 240 are started up when the count value is an odd value, the Enable signal may be output when the count value is an even value. Note that in a case where N number of modules exist, a relay control cycle of each module may be N times the internal control cycle. In a case where N number of relays exist, a relay control cycle of each module may be N times the internal control cycle. The relay control cycle may correspond to the delay time between relays.

### Embodiment 3

In Embodiment 2, the on timings of the plurality of relays 220, 230, and 240 are offset on the basis of the internal control cycle. In Embodiment 3, the Enable_IN signal is used as a timing control signal for turning on the relays 220, 230, and 240. For example, the relays 220, 230, and 240 can be turned on in a permission period in which the earlier stage module asserts the Enable_OUT signal. The earlier stage module negates the Enable_OUT signal in a period in which it should turn on the relays 220, 230, and 240. The period in which the Enable_OUT signal is negated is a no-permission period (prohibited period). The earlier stage module and the later stage module each start up the plurality of relays in order.

### 1. Power Supply Apparatus

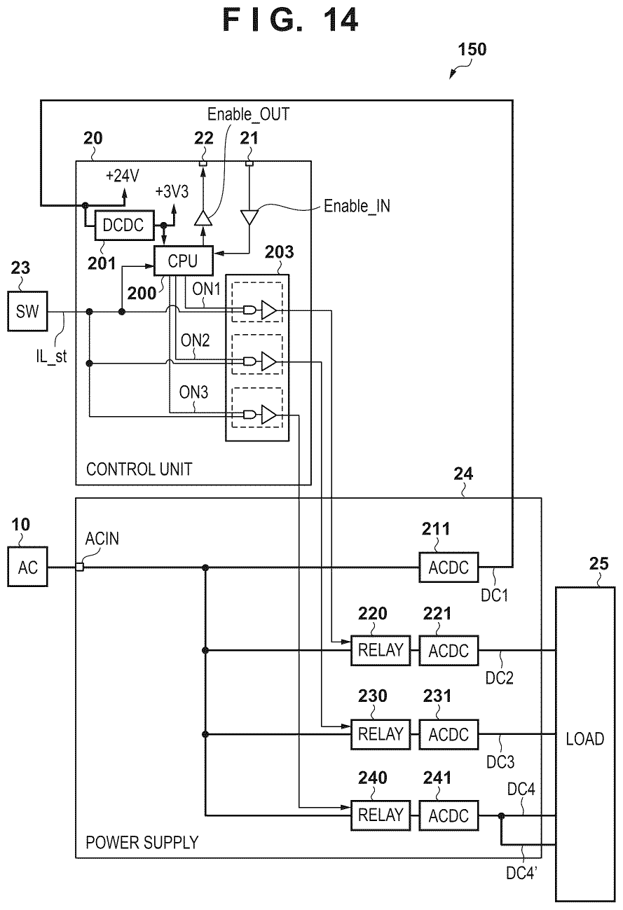

FIG. 14 illustrates the power supply apparatus 150 according to Embodiment 2. In Embodiment 3, as opposed to in Embodiments 1 and 2, the control unit 20 constantly supplies the +24 V power supply from the AC/DC conversion unit 211 independent of the state of the input terminal 21. In Embodiment 3, the Enable_IN signal input from the input terminal 21 is input to the CPU 200 and used as a permission signal for relay on control.

### 2. Timing Chart

### 2.1 Startup Operation

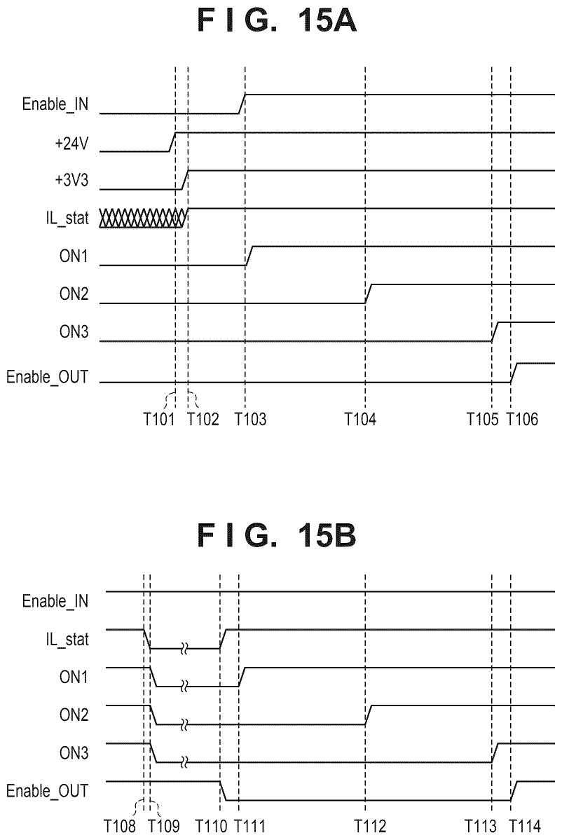

FIG. 15A illustrates the startup operation. In time T101, a breaker is turned on, causing an alternating current to be input from the AC power supply 10 to the ACIN terminal. Accordingly, the AC/DC conversion unit 211 starts generating the +24 V power supply.

At time T102, the DC/DC conversion unit 201 starts generating the +3V3 power supply. This causes the CPU 200 to start up.

At time T103, the CPU 200 detects that the Enable_IN signal input to the input terminal 21 has been asserted. Accordingly, the CPU 200 asserts the ON1 signal. In this manner, the Enable_IN signal is a permission signal for relay on control.

Time T104 is the time after a predetermined delay time has passed from time T103. At time T104, the CPU 200 asserts the ON2 signal.

Time T105 is the time after a predetermined delay time has passed from time T103. At time T105, the CPU 200 asserts the ON3 signal.

Time T106 is the time after all of the relays 220, 230, and 240 are turned on. At time T106, the CPU 200 asserts the Enable_OUT signal output from the output terminal 22. Accordingly, the later stage module permits relay on control.

### 2.2 Interlock Operation

FIG. 15B illustrates an interlock operation. At time T108, the door is open and the door switch 23 is turned off. Accordingly, the IL_st signal is negated.

At time T109, the CPU 200 detects the negation of the IL_st signal. The CPU 200 negates all of the ON1 signal to the ON3 signal in response to the detection result indicating that the IL_st signal has been negated.

At time T110, the door is closed and the door switch 23 is turned on. Accordingly, the IL_st signal is asserted. Also, the CPU 200 negates the Enable_OUT signal output from the output terminal 22. The negated Enable_OUT signal functions as a prohibition signal (no-permission signal) for prohibiting the later stage module turning the relay on. Accordingly, the earlier stage module and the later stage module do not simultaneously turn the relay on. Also, the negated Enable_OUT signal may be referred to as a declaration signal for declaring that the earlier stage module has started relay on control. The CPU 200 starts turning on the relays 220, 230, and 240 under the condition that the IL_st signal is asserted (door open) and the Enable_IN signal is asserted (relay control permission). The Enable_IN signal is the Enable_OUT signal input from the output terminal 22 of the earlier stage module to the input terminal 21 of the later stage module. The Enable_IN signal is used as a permission signal for relay on control. Thus, because the Enable_IN signal is negated, the relay is not controlled to off.

Time T111 is the time after a predetermined delay time has passed from time T110. The CPU 200 asserts the ON1 signal in response to the detection result indicating that both signals are being asserted. Accordingly, the relay 220 is turned on. Time T111 is the time after a predetermined delay time has passed from time T110 when both the Enable_IN signal and the IL_st signal were asserted.

Time T112 is the time after a predetermined delay time has passed from time T110. At time T112, the CPU 200 asserts the ON2 signal in response to the detection result indicating that both signals are being asserted. Accordingly, the relay 230 is turned on.

Time T113 is the time after a predetermined delay time has passed from time T110. At time T113, the CPU 200 asserts the ON3 signal in response to the detection result indicating that both signals are being asserted. Accordingly, the relay 240 is turned on.

At time T114, the CPU 200 determines whether or not all of the relays 220, 230, and 240 have been turned on. The CPU 200 asserts the Enable_OUT signal in response to the determination result indicating that all of the relays 220, 230, and 240 have been turned on. Accordingly, the CPU 200 can permit relay on control for the later stage module.

### 3. CPU Function

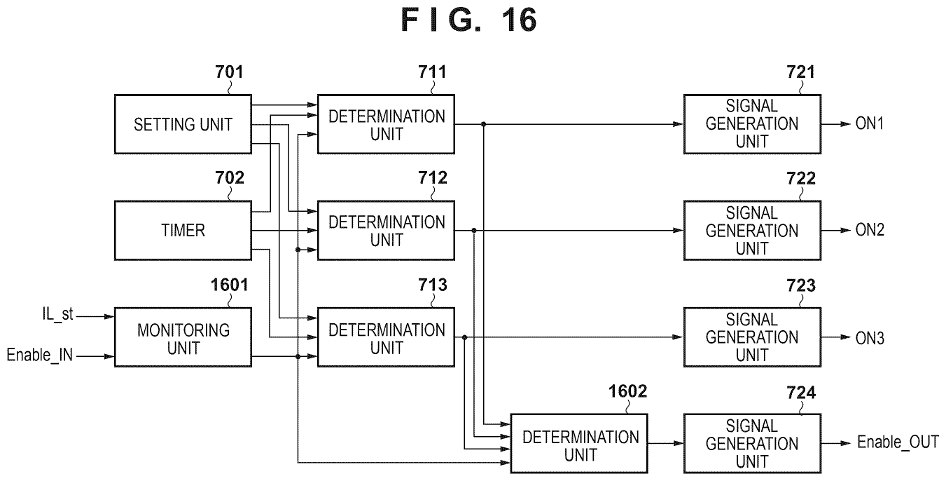

FIG. 16 illustrates the functions implemented by the CPU 200 according to Embodiment 3. The monitoring unit 703 of Embodiment 1 is replaced with a monitoring unit 1601. The monitoring unit 1601 monitors, detects, or determines whether or not the Enable_IN signal input from the earlier stage module to the input terminal 21 is asserted and whether or not the IL_st signal is asserted. If the Enable_IN signal is asserted and the IL_st signal is asserted, the determination unit 711 commands the signal generation unit 721 to generate the ON1 signal at the predetermined delay time delay4. If the Enable_IN signal is asserted and the IL_st signal is asserted, the determination unit 712 commands the signal generation unit 722 to generate the ON2 signal at the predetermined delay time delay5. If the Enable_IN signal is asserted and the IL_st signal is asserted, the determination unit 713 commands the signal generation unit 723 to generate the ON3 signal at the predetermined delay time delay6.

In a case where the Enable_IN signal is asserted and the IL_st signal is asserted, a determination unit 1602 commands the signal generation unit 724 to negate the Enable_OUT signal. In a case where all of the ON1 signal to the ON3 signal are asserted, the determination unit 1602 commands the signal generation unit 724 to assert the Enable_OUT signal.

### 4. Flowchart

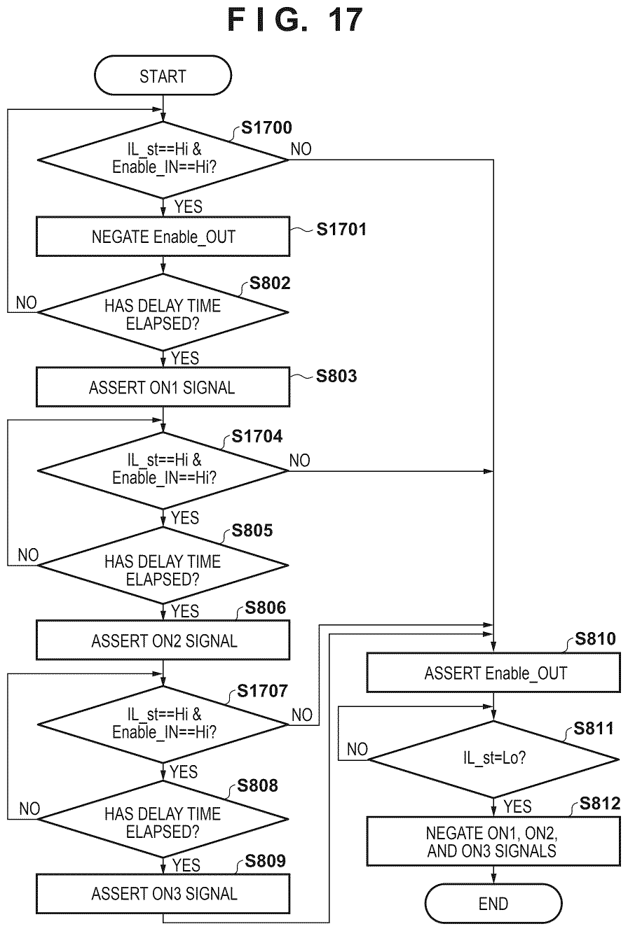

FIG. 17 is a flowchart illustrating the control method according to Embodiment 3. The differences with Embodiment 1 will be described in detail below.

S801 is replaced with S1700 and S1701. In S1700, the CPU 200 determines whether or not the Enable_IN signal is asserted and whether or not the IL_st signal is asserted. In a case where the Enable_IN signal is asserted and the IL_st signal is asserted, the CPU 200 proceeds from S1700 to S1701. In a case where at least one of the Enable_IN signal and the IL_st signal is negated, the CPU 200 proceeds from S1700 to S810. In S810, the CPU 200 asserts the Enable_OUT signal and permits relay on control for the later stage module.

In S1701, the CPU 200 negates the Enable_OUT signal and proceeds from S1701 to S802. Accordingly, relay on control is prohibited for the later stage module.

S804 is replaced with S1704. In S1704, the CPU 200 determines whether or not the Enable_IN signal is asserted and whether or not the IL_st signal is asserted. In a case where the Enable_IN signal is asserted and the IL_st signal is asserted, the CPU 200 proceeds from S1704 to S805. In a case where at least one of the Enable_IN signal and the IL_st signal is negated, the CPU 200 proceeds from S1700 to S810.

S807 is replaced with S1707. In S1707, the CPU 200 determines whether or not the Enable_IN signal is asserted and whether or not the IL_st signal is asserted. In a case where the Enable_IN signal is asserted and the IL_st signal is asserted, the CPU 200 proceeds from S1707 to S808. In a case where at least one of the Enable_IN signal and the IL_st signal is negated, the CPU 200 proceeds from S1707 to S810.

According to Embodiment 3, the CPU 200 monitors both the state of the door switch and the Enable_IN signal and turns on the relays 220, 230, and 240 only in a case where both are in an asserted state. The CPU 200 negates the Enable_OUT signal to the later stage module in the period in which its module is performing relay on control. Accordingly, the later stage module performing relay on control in a period in which the later stage module is performing on control of the relays 220, 230, and 240 can be avoided. Thus, the inrush current is reduced.

In Embodiment 3, the +24 V power supply is constantly supplied to the control unit 20, as an example. As in Embodiment 1 and Embodiment 2, the supply of the +24 V power supply may be started by the Enable_IN signal. In this case, it is sufficient that a permission signal relating to relay on control is prepared separate to the Enable_IN signal for startup permission.

According to Embodiment 3, the Enable signal functions as a permission signal or a prohibition signal input from the outside (controller 30, earlier stage module) of the power supply apparatus 150. In the permission period in which a permission signal has been input or a prohibition signal has not been input, the relays 220, 230, and 240 are switched from off to on according to the state of the door switch 23. In the no-permission period in which a permission signal has not been input or a prohibition signal has been input, the relays 220, 230, and 240 are kept in the off state independent of the state of the door switch 23.

### Embodiment 4

In Embodiment 1 and Embodiment 3, the ON1 signal to the ON3 signal are each delayed using the timer 702, as an example.

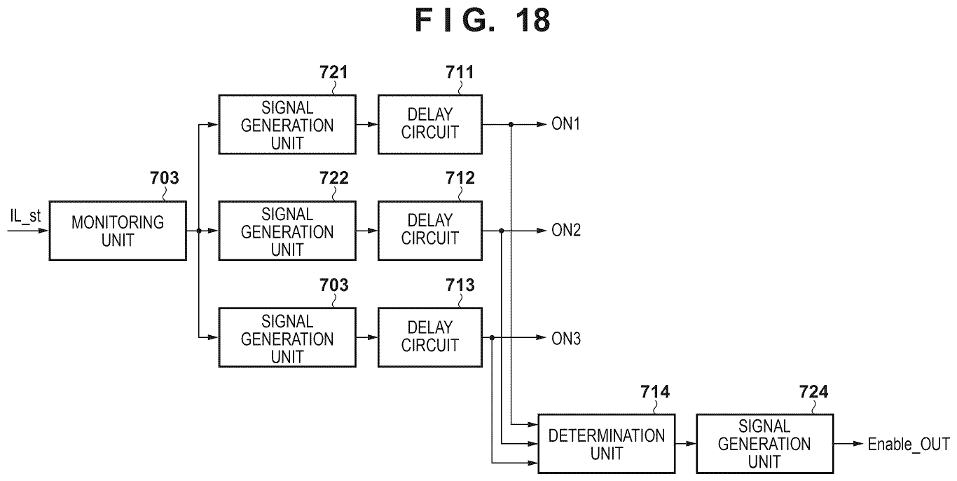

FIG. 18 illustrates an example of a modification of Embodiment 1. Instead of the setting unit 701, the timer 702, and the determination units 711, 712, and 713, delay circuits 1801, 1802, and 1803 are used. When the IL_st signal is negated (door open), the monitoring unit 703 commands the signal generation units 721, 722, 723 to each generate an ON signal. The signal generation units 721, 722, and 723 generate the ON1 signal, the ON2 signal, and the ON3 signal, respectively. The delay circuit 1801 is connected to the output terminal of the signal generation unit 721 and delays the ON1 signal by the predetermined delay time delay4. The delay circuit 1802 is connected to the output terminal of the signal generation unit 722 and delays the ON2 signal by the predetermined delay time delay5. The delay circuit 1803 is connected to the output terminal of the signal generation unit 723 and delays the ON3 signal by the predetermined delay time delay5. When the delayed ON1 signal, ON2 signal, and ON3 signal are all asserted, the determination unit 714 causes the signal generation unit 724 to assert the Enable_OUT signal. The delay circuits 1801 to 1803 may be implemented by an analog element combination (analog circuit) including a resistor and a capacitor, for example, or by a logic circuit (digital circuit). The delay circuits 1801, 1802, and 1803 may be disposed between the CPU 200 and the relay drive unit 203.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., a CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-171513, filed Sep. 30, 2024, which is hereby incorporated by reference herein in its entirety.

What is claimed is:

1. A power supply apparatus comprising:
a first power supply unit configured to be supplied with an alternating current (AC) power from an AC power supply;
a second power supply unit configured to be supplied with the AC power;
a first relay connected between the AC power supply and an input of the first power supply unit, wherein in an on state the AC power is supplied to the first power supply unit and in an off state the AC power is not supplied to the first power supply unit;
a second relay connected between the AC power supply and an input of the second power supply unit, wherein in an on state the AC power is supplied to the second power supply unit and in an off state the AC power is not supplied to the second power supply unit;
a first interlock switch configured to transition between a first state when a predetermined first interlock condition is satisfied and a second state when the predetermined first interlock condition is not satisfied; and
a controller configured to control:
when the first interlock switch transitions from the second state to the first state, switching of the first relay from the on state to the off state and switching of the second relay from the on state to the off state, and
when the first interlock switch transitions from the first state to the second state and after elapse of a first delay from the transition to the second state of the first interlock switch, switching of the first relay from the off state to the on state, and after elapse of a second delay longer than the first delay from the transition to the second state of the first interlock switch, switching of the second relay from the off state to the on state.

2. The power supply apparatus according to claim 1, further comprising:
a third power supply unit configured to be supplied with the AC power; and
a third relay connected between the AC power supply and an input of the third power supply unit, wherein in an on state the AC power is supplied to the third power supply unit and in an off state the AC power is not supplied to the third power supply unit,
wherein the controller is further configured to control:
when the first interlock switch transitions from the second state to the first state, switching the first relay from the on state to the off state, the second relay from the on state to the off state, and the third relay from the on state to the off state, and
when the first interlock switch transitions from the first state to the second state and after elapse of the first delay, switching of the first relay from the off state to the on state, when the second delay elapses, switches the second relay from the off state to the on state, and after elapse of a third delay longer than the second delay, switching of the third relay from the off state to the on state.

3. The power supply apparatus according to claim 1, further comprising:
a third power supply unit configured to be supplied with the AC power;
a third relay connected between the AC power supply and an input of the third power supply unit, wherein in on state the AC power is supplied to the third power supply unit and in an off state the AC power is not supplied to the third power supply unit; and
a second interlock switch configured to transition between the first state when a predetermined second interlock condition is satisfied and the second state when the predetermined second interlock condition is not satisfied,
wherein the controller is further configured to control:
when the second interlock switch transitions from the second state to the first state, switching the third relay from the on state to the off state, and
when the second interlock switch transitions from the first state to the second state and after elapse of a third delay longer than the second delay, switching the third relay from the off state to the on state.

4. The power supply apparatus according to claim 1, wherein:
the controller is further configured to control output of a startup permission signal to another power supply apparatus, and
the startup permission signal is output after each of the first relay and the second relay have transitioned to the on state.

5. The power supply apparatus according to claim 3, wherein:
the controller is further configured to control output of a startup permission signal to another power supply apparatus after each of the first relay, the second relay, and the third relay have transitioned to the on state.

6. The power supply apparatus according to claim 1, further comprising:
a counter configured to count a control cycle of a constant interval,
wherein, the controller is further configured to control switching the first relay from the off state to the on state in a case where a count value of the counter is a first even value and switching the second relay from the off state to the on state in a case where a count value of the counter is a second even value greater than the first even value.

7. The power supply apparatus according to claim 3, further comprising:
a counter configured to count a control cycle of a constant interval,
wherein, the controller is further configured to control switching the first relay from the off state to the on state in a case where a count value of the counter is a first even value, switching the second relay from the off state to the on state in a case where a count value of the counter is a second even value greater than the first even value, and switching the third relay from the off state to the on state in a case where a count value of the counter is a third even value greater than the second even value.

8. The power supply apparatus according to claim 7, wherein:
the controller is further configured to control output of a signal corresponding to a starting point of a counter of a control cycle for another power supply apparatus to the another power supply apparatus after each of the first relay, the second relay, and the third relay have transitioned to the on state and in a case where a count value of the counter is an odd value.

9. The power supply apparatus according to claim 1, wherein:
the controller is further configured to:
in a permission period in which a permission signal from outside the power supply apparatus has been input or a prohibition signal has not been input, when the first interlock switch transitions from the first state to the second state and when the first delay elapses from a time when transition to the second state occurred, control switching of the first relay from the off state to the on state, and after the second delay elapses, control switching of the second relay from the off state to the on state, and
in a no-permission period in which the permission signal has not been input or the prohibition signal has been input, maintain the first relay and the second relay in the off state.

10. An image forming apparatus comprising:
a first module including a first casing; and
a second module including a second casing different from the first casing,
wherein the first module includes:
a first power supply unit configured to be supplied with an alternating current (AC) power from an AC power supply,
a second power supply unit configured to be supplied with the AC power,
a first relay connected between the AC power supply and an input of the first power supply unit, wherein in an on state the AC power is supplied to the first power supply unit and in an off state the AC power is not supplied to the first power supply unit,
a second relay connected between the AC power supply and an input of the second power supply unit, wherein in an on state the AC power is supplied to the second power supply unit and in an off state the AC power is not supplied to the second power supply unit,
a first interlock switch configured to transition between a first state when a predetermined first interlock condition is satisfied and a second state when the predetermined first interlock condition is not satisfied, and
a first controller configured to control the first relay and the second relay,
wherein the second module includes:
a third power supply unit configured to be supplied with the AC power,
a fourth power supply unit configured to be supplied with the AC power,
a third relay connected between the AC power supply and an input of the third power supply unit, wherein in an on state the AC power is supplied to the third power supply unit and in an off state the AC power is not supplied to the third power supply unit,
a fourth relay connected between the AC power supply and an input of the fourth power supply unit, wherein in an on state the AC power is supplied to the fourth power supply unit and in an off state the AC power is not supplied to the fourth power supply unit,
a second interlock switch configured to transition between the first state when a predetermined second interlock condition is satisfied and the second state when the predetermined second interlock condition is not satisfied, and
a second controller configured to control the third relay and the fourth relay,
wherein the first controller is further configured to:
when the first interlock switch transitions from the second state to the first state, control switching of the first relay from the on state to the off state and the second relay from the on state to the off state, and
when the first interlock switch transitions from the first state to the second state after elapse of a first delay from the transition to the second state of the first interlock switch, control switching of the first relay from the off state to the on state, and after elapse of a second delay longer than the first delay from the transition to the second state of the first interlock switch, control switching of the second relay from the off state to the on state, and
wherein the second controller is further configured to:
when the second interlock switch transitions from the second state to the first state, control switching of the third relay from the on state to the off state and the fourth relay from the on state to the off state, and
when the second interlock switch transitions from the first state to the second state and after elapse of a third delay from the transition to the second state of the second interlock switch, control switching of the third relay from the off state to the on state, and after elapse of a fourth delay longer than the third delay from the transition to the second state of the second interlock switch, control switching of the fourth relay from the off state to the on state.

11. The image forming apparatus according to claim 10, wherein:
the first controller is further configured to control:
output of a first permission signal to the second module after the first relay and the second relay have switched from the off state to the on state, and
the second controller is further configured to, in a first permission period in which the first controller outputs the first permission signal:
when the second interlock switch transitions from the second state to the first state, control switching of the third relay from the on state to the off state and the fourth relay from the on state to the off state, and
when the second interlock switch transitions from the first state to the second state and when a third delay elapses, control switching of the third relay from the off state to the on state, and when a fourth delay elapses, control switching of the fourth relay from the off state to the on state.

12. The image forming apparatus according to claim 10, wherein:
the first controller includes a first counter configured to count a first control cycle of a constant interval,
the second controller includes a second counter configured to count a second control cycle of a constant interval,
the first controller is further configured to control switching of the first relay from the off state to the on state in a case where a count value of the first counter is a first even value and switching of the second relay from the off state to the on state in a case where a count value of the first counter is a second even value greater than the first even value, and
the second controller is further configured to control switching of the third relay from the off state to the on state in a case where a count value of the second counter is a third even value and switching of the fourth relay from the off state to the on state in a case where a count value of the second counter is a fourth even value greater than the third even value.

13. The image forming apparatus according to claim 12, wherein:
a starting point of the first control cycle and a starting point of the second control cycle are offset from one another.

14. The image forming apparatus according to claim 13, wherein:
the first controller is further configured to control output of a predetermined control signal to the second controller after the first relay and the second relay are turned on, and
the second controller is further configured to start a count of the second control cycle using the predetermined control signal as a starting point.

15. The image forming apparatus according to claim 11, wherein:
the first controller is further configured to negate a predetermined control signal for the second controller when the first interlock switch transitions from the first state to the second state and assert the predetermined control signal after the first relay and the second relay are turned on, and
the second controller is further configured to not turn on the third relay and the fourth relay in a period in which the predetermined control signal is negated and to turn on the third relay and the fourth relay in a period in which the predetermined control signal is asserted when the second interlock switch switches from the first state to the second state.

16. The image forming apparatus according to claim 10, further comprising:
a third module including a third casing, wherein the third module includes:
a fifth power supply unit configured to be supplied with the AC power,
a sixth power supply unit configured to be supplied with the AC power,
a fifth relay connected between the AC power supply and an input of the fifth power supply unit, wherein in an on state the AC power is supplied to the fifth power supply unit and in an off state the AC power is not supplied to the fifth power supply unit,
a sixth relay connected between the AC power supply and an input of the sixth power supply unit, wherein in an on state the AC power is supplied to the sixth power supply unit and in an off state the AC power is not supplied to the sixth power supply unit,
a third interlock switch configured to transition between the first state when a predetermined third interlock condition is satisfied and the second state when the predetermined third interlock condition is not satisfied, and
a third controller configured to:
when the third interlock switch transitions from the second state to the first state, control switching of the fifth relay from the on state to the off state and the sixth relay from the on state to the off state, and
when the third interlock switch transitions from the first state to the second state after elapse of a fifth delay from transition to the second state, control switching of the fifth relay from the off state to the on state, and after elapse of a sixth delay longer than the fifth delay, control switching of the sixth relay from the off state to the on state.

17. An image forming apparatus comprising a plurality of modules that each comprise a power supply apparatus including:
a first power supply unit configured to be supplied with an alternating current (AC) power from an AC power supply;
a second power supply unit configured to be supplied with the AC power;
a first relay connected between the AC power supply and an input of the first power supply unit, wherein in an on state the AC power is supplied to the first power supply unit and in an off state the AC power is not supplied to the first power supply unit;
a second relay connected between the AC power supply and an input of the second power supply unit, wherein in an on state the AC power is supplied to the second power supply unit and in an off state the AC power is not supplied to the second power supply unit;
a interlock switch configured to enter a first state when a predetermined interlock condition is satisfied and a second state when the predetermined interlock condition is not satisfied, and
a controller configured to control the first relay and the second relay to:
in response to the interlock switch transitioning from the second state to the first state, switch the first relay from the on state to the off state and the second relay from the on state to the off state, and
in response to the interlock switch transitioning from the first state to the second state and elapse of a first delay, switch the first relay from the off state to the on state and, after elapse of a second delay longer than the first delay, switch the second relay from the off state to the on state.

18. An image forming apparatus comprising N modules, wherein each of the N modules comprises a power supply apparatus including:
a first power supply unit configured to be supplied with an alternating current (AC) power from an AC power supply;
a second power supply unit configured to be supplied with the AC power;
a first relay connected between the AC power supply and an input of the first power supply unit, wherein in an on state the AC power is supplied to the first power supply unit and in an off state the AC power is not supplied to the first power supply unit;
a second relay connected between the AC power supply and an input of the second power supply unit, wherein in on state the AC power is supplied to the second power supply unit and in an off state the AC power is not supplied to the second power supply unit;
an interlock switch that enters an off state when a predetermined interlock condition is satisfied and an on state when the predetermined interlock condition is not satisfied; and
a controller configured to:
execute N number of remainder operations with respect to count values of internal control cycles, obtain a solution to the N number of remainder operations, and control switching of the first relay from the off state to the on state at a first timing at which the solution is a first value, and control switching of the second relay from the off state to the on state at a second timing later than the first timing at which the solution is the first value.

19. The image forming apparatus according to claim 18, wherein:
the controller is further configured to control output of a control signal corresponding to a starting point of an internal control cycle of another module to the another module from among the N modules at a timing at which the solution is a second value different from the first value.

20. The image forming apparatus according to claim 18, wherein:
starting points of the internal control cycles of each of the N modules are offset from one another.
